(19) United States
(12) Patent Application Publication
(10) Pub. No.: US 2003/0029062 A1
(43) Pub. Date: Feb. 13, 2003

(54) Method and device for determining mattress rotation

(76) Inventor: Margaret Esterman, Alexander, NC (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/214,563

(22) Filed: Aug. 9, 2002

Related U.S. Application Data
(63) Continuation of application No. 09/756,116, filed on Jan. 9, 2001, now abandoned.

(51) Int. Cl. G09F 3/20

(52) U.S. Cl. 40/5

(57) ABSTRACT

A method and device for determining mattress rotation sequence and time by tracking the position of cues on a graphically imprinted device. In a preferred embodiment a board is imprinted with cues representing the twelve calender months of the year. A pair of hanging slots represents the direction or rotation to turn the mattress (i.e., head to foot or over). Each month and mattress position has a corresponding cue. If desired a first label is affixed to the foot-end of the top side of the mattress and a second label of a different color or configuration is affixed to the foot-end of the bottom side of the mattress. The consumer selects the time and mattress-rotation cue wherein a cue may be any signal which is directional, tactile, visual or audible that prompts a user to take a certain action.

This application is a continuation of of U.S. application Ser. No. 09/756,116; (now abandoned) filed on Jan. 9, 2001 and titled: Method and device for determining mattress rotation.

### BACKGROUND

It is well known that rotating a mattress on a periodic basis will extend the life and improve the comfort of the mattress. Rotation of a mattress distributes the wear among the surfaces and allows air to circulate among the various surfaces. Mattresses and futons develop wear patterns based on frequency of use and the weight of the user. While there is quite a bit of difference as to what various manufacturers actually recommend, it is desirable to rotate a sleep system often to promote even wear; to allow air to circulate among the various surfaces; and, to reduce the inevitable wear patterns that develop on all mattresses. The only mattresses that don't require rotation are the air supported sleep systems such as those marketed under the name “Comforter.” Such products are made softer or firmer through air support which eliminates the wear pattern problem. How long a sleep set lasts depends on its original quality and how it is used. The performance of a poor quality set can deteriorate quickly while top quality sets can be expected to perform well for many years. Regardless of the quality of the sleep system, the life of the system can be extended and sleep quality enhanced with regular rotation. A set should generally last for about ten years of nightly use if properly rotated; and, back injury due to sleeping on unevenly worn mattresses can thereby be avoided.

U.S. Pat. No. 4,095,299 discloses a label and method for determining mattress rotation. A first label is affixed to the upper surface of the mattress and a second label is affixed to the lower surface of the mattress. The labels provide instruction for the mattress to be turned over. There is no reminder system, such as a monthly date, to remind one when to turn the mattress, only a label to indicate mattress orientation.

There are also numerous mattress turning devices which assist one in physically turning a mattress. Mandelbaum (U.S. Pat. No. 2,445,030) describes a mattress turning device that physically facilitates the reversal of a mattress. The reference does not mention any reminder label or device associated with the turning device to remind a person of a particular time or orientation in which the mattress is to be turned. There are also mattresses with indicia on the ends, such as Muzaurieta (U.S. Pat. No. 3,376,585) which depicts a mattress having indica on the end of the mattress; however, the indicia relates to instructions for turning on and off a musical device contained within the mattress.

### SUMMARY

The invention relates to a method and device for indicating when and in which direction a mattress should be turned in order to extend the life of the mattress. The invention is also applicable to futons and other sleeping systems.

It is often difficult to remember the time of the last mattress rotation and the direction in which the mattress was flipped. A different turning motion is needed from month to month in order to cycle the mattress evenly through the four mattress positions. In some months a horizontal plane turn from head to foot is necessary and in other months a vertical plane turn from topside to bottom side is necessary. The method and device of the present invention easily solves this problem with a simple and inexpensive reminder device that can be kept at a bedside or attached directly to a mattress or bedframe.

In one embodiment of the present invention a block or board is imprinted with icons representing four mattress positions and the twelve calendar months of the year. One pair of icons represents the top and bottom sides of the mattress , another pair of icons represents the head and the foot ends of the mattress. Each month and mattress position has a corresponding hole for receiving a peg. A first label is affixed to one end of the top side of the mattress and a second label of a different color or configuration is affixed to the same end of the bottom side of the mattress. The consumer places the peg in the icon hole corresponding to the position of the labels on the mattress, and places a peg in the hole corresponding to the month of the year. The mattress is thus turned from side to side or end to end, according to the sequence of icons. Alternatively, in place of a mechanically movable marker the device can have an electronic display signal to indicate the mattress rotation and time frame. In another electronic embodiment only the mattress-rotation icons are graphically displayed. A signal alerts the user that it is time to rotate the mattress and the display device displays the next mattress rotation. The electronic signal can be an auditory alarm, a tactile alarm or a visual display such as a blinking light.

In yet another embodiment of the present invention a board is imprinted with cues representing the twelve calender months of the year. Mattress-rotation cues represent the direction to turn the mattress (i.e., in the vertical plane, or horizontal plane). Each month and mattress rotation plane has a corresponding cue. If desired a first label is affixed to the foot-end of the top side of the mattress and a second label of a different color or configuration is affixed to the foot-end of the bottom side of the mattress. The consumer selects the time and mattress-rotation cue.

A cue may be any signal which is directional, tactile, visual or audible that prompts a user to take a certain action.

In another embodiment the reminder device has two rotatable disks attached together via a rivet. The disks are imprinted with time orientation cues and mattress-rotation plane cues. The mattress is turned according to the sequence of cues on the disks.

The device can be used in an institutional environment such as a hospital or hotel where many employees are responsible for the task of turning mattresses. Use of the device in an institutional setting can considerably extend the wear and comfort of multiple mattresses resulting in significant savings.

### BRIEF DESCRIPTION OF THE DRAWINGS

Various other features and attendant advantages of the present invention will be more fully appreciated as the same become better understood when considered in conjunction with the accompanying drawings, in which like reference characters designate the same or similar parts throughout the several views, and wherein:

FIG. 1 is a perspective view of an embodiment of the present invention showing mattress-rotation icons and month of the year icons.

FIG. 2 views 2(a) and 2(b) show mattress indicia

FIG. 3 is a view of another embodiment of the present invention showing mattress-rotation icons on a first rotatable disk and time-related icons on a second rotatable disk.

FIG. 4 is a view of another embodiment showing an electronic reminder device.

FIG. 5 is a view of another embodiment of the present invention. The reminder device comprises two disks joined together by a rivet.

FIG. 6 is a view of another embodiment of the present invention showing an alternative configuration.

FIG. 7 is a view of another embodiment of the present invention showing hanging slots.

FIG. 8 is a view of another embodiment showing movable pointers.

FIG. 9 is a view of another embodiment. Plural disks are attached with a rivet which allows all of the disks to rotate.

FIG. 10 is a view of another embodiment showing a display with a front surface (FIG. 10a) and a back surface (FIG. 10b).

FIG. 11 is a view of another embodiment showing a sphere imprinted with mattress-rotation plane cues. FIG. 11a shows the sphere is seated in a box. FIG. 11b shows the arrangement of mattress-rotation cues on the sphere. FIG. 11c depicts the individual mattress-rotation cues.

FIG. 12 is a view of another embodiment showing top and bottom imprinted dials mounted on a column having upper and lower flanges. FIGS. 12a and 12b show the arrangement of dials and flanges. FIG. 12c depicts the assembled embodiment.

### DESCRIPTION OF PREFERRED EMBODIMENTS

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

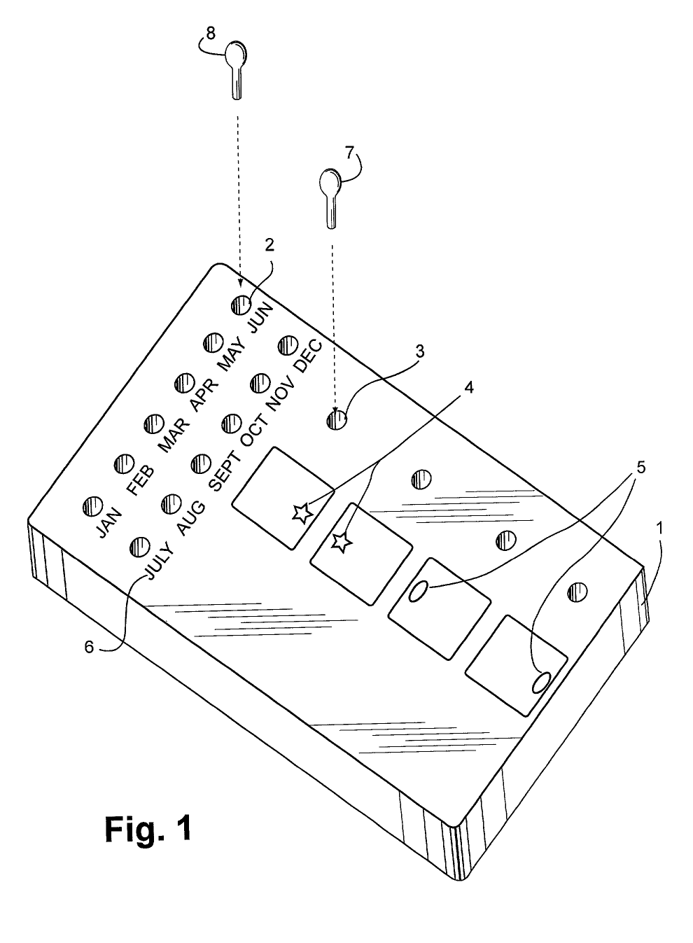

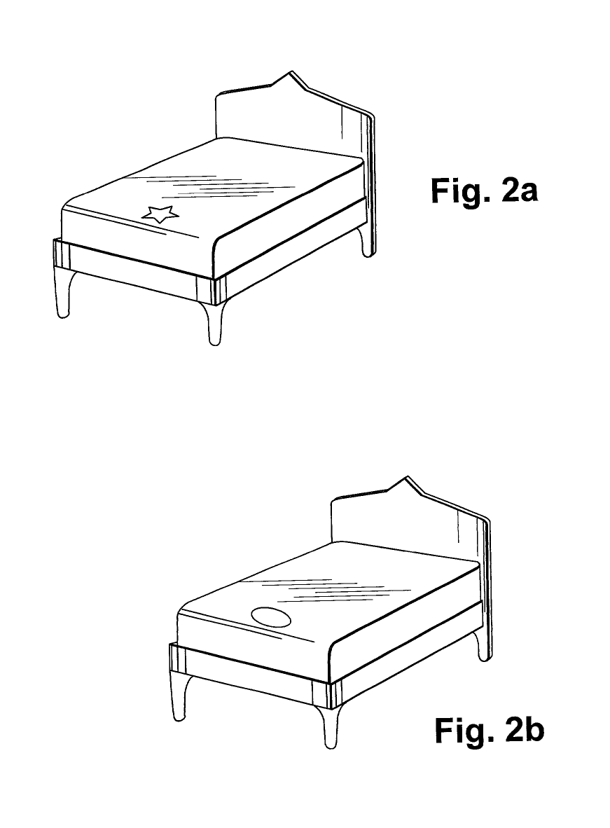

In FIG. 1, a block or board (1) is imprinted with icons representing four possible mattress positions (4) (5) and the calendar months of the year (6). It is recommended that mattresses be turned about every month to extend the life and comfort of the mattress. The device of the present invention helps keep track of the month of the last mattress rotation. Once the mattress is turned, the new position is noted by inserting a peg (7) next to the corresponding mattress rotation icon on the device. The second peg (8) is inserted into the hole next to the current month on the device. In the following months the mattress is turned to match the label positions on the device with the label position on the mattress. The icons are followed from top to bottom to insure that all the mattress positions are used sequentially and the wear on the mattress is equally distributed.

The twelve calendar months are represented by any indicia that will provide a time reference which prompts a person to rotate the mattress, such as the seasons or holidays, can be used. One pair of icons represents the top and bottom sides of the mattress (4), another pair of icons represents the head and the foot ends of the mattress (5). In a preferred embodiment each month and mattress position has a corresponding hole (2) for receiving a peg (3), however other marker systems, such as magnets or lights can be used to mark the selected icon.

A first label is affixed to the foot-end of the top side of the mattress and a second label of a different color, icon or configuration is affixed to the foot-end of the bottom side of the mattress. In a preferred embodiment the labels are color coded to match the color coded mattress rotation icons on the block or board. Any means to mark the mattress ends can be used as long as they correlate to the icons on the device.

The consumer places the peg (7) in the icon hole corresponding to the position of the labels on the mattress (3), and places a peg in the hole (2) corresponding to the month of the year. The mattress is then turned from side to side or end to end, according to the sequence of icons.

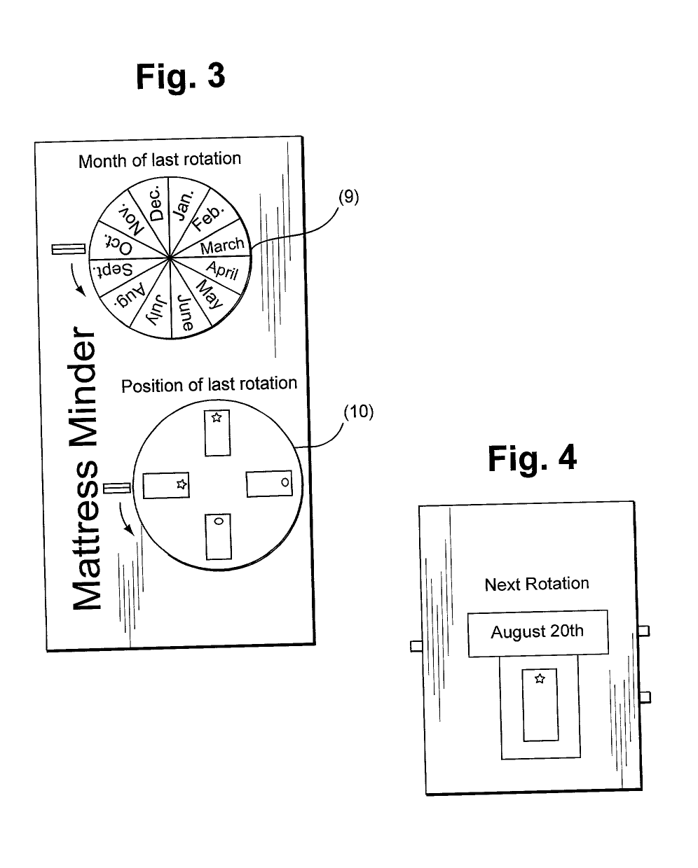

In another embodiment (FIG. 3) the months of the year are imprinted on a rotatable disk (9) which the user turns to indicate either the month the mattress was last turned or the month of the next rotation. A second disk (10) is imprinted with the four possible mattress rotation cues. The user turns the disk to keep track of the last mattress position or to indicate the next mattress position.

In another embodiment (FIG. 4) the reminder device is electronic. The electronic embodiment displays the date of last rotation or the date of the next rotation. Alternatively, no date at all is displayed and the device generates an automatic signal at a preset time to prompt the user to turn the mattress. Thus, an alarm-type function is preset. Turning off the signal resets the device to the next time and rotation cues sequence. The preset signal can be visual such as a blinking light, auditory such as a beep or tactile such as a raised bump or flag. Any signal to prompt the user to turn the mattress is suitable. The electronic embodiments display the selected mattress rotation cue icon of the last rotation or of the next rotation. The mattress rotation cue icon corresponds to the labels that mark the mattress ends.

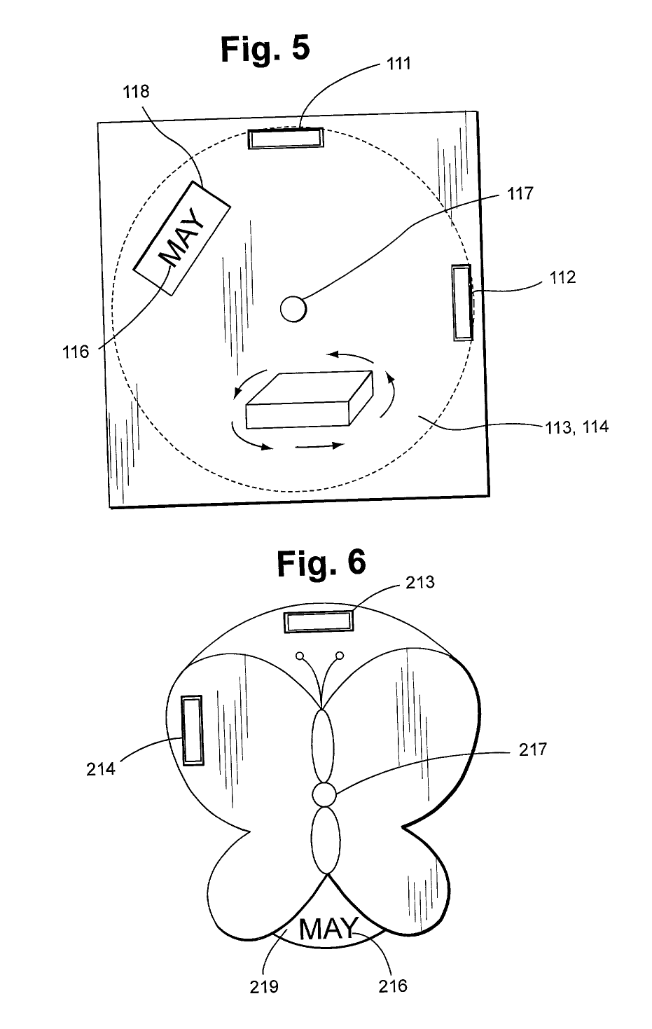

In the FIGS. 5, 6, 7, 8 ,9, 10, 11 and 12 embodiments of the present invention a display which may be for example a block, placard, board or mattress side is imprinted with cues representing mattress rotation directions (i.e., vertical plane or horizontal plane) and cues representing time (e.g. the calendar months of the year). By cue it is meant any icon or signal which is tactile, visual or audible that prompts a user to take a certain action.

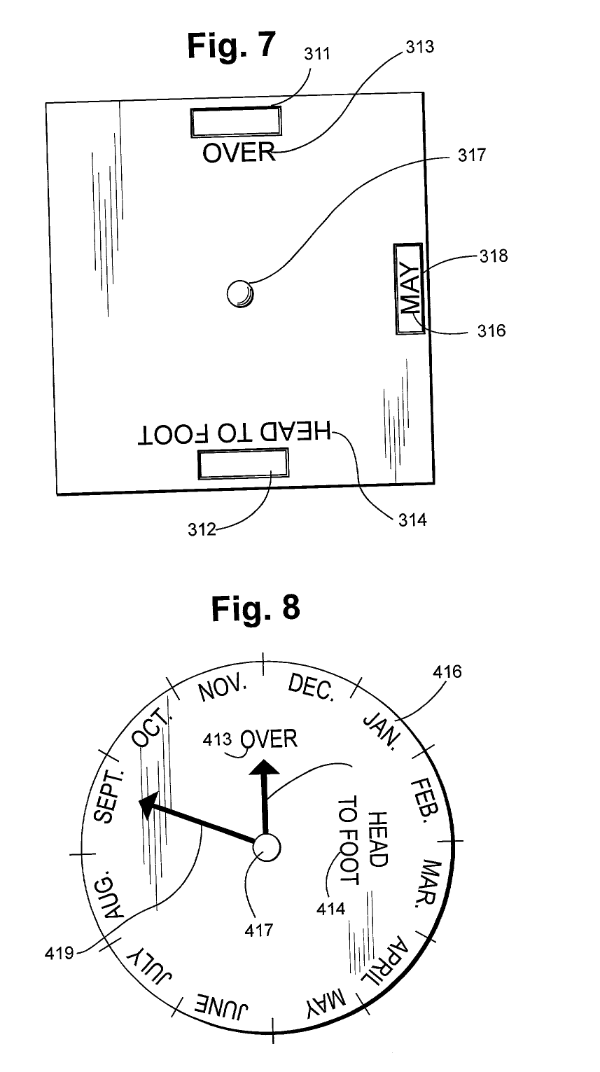

In a FIG. 5 embodiment a display has two hanging slots (111, 112). In one position the first slot (111) corresponds to a horizontal-plane mattress turn. If the display is rotated, the second hanging slot (112) corresponds to a vertical-plane mattress turn. As the user turns the display a different mattress rotation direction (113, 114) is shown. The device may be equipped with two or more slots, tabs, rings, or other hanging fasteners arranged around the edge of the display. In various embodiments the slots are set 90 degrees (FIGS. 5, 6) and /or 180 degrees (FIG. 7) to one another. The device may be suspended in alternate positions by means of a loop or clip or other fastener from the mattress handles or the bed posts. Hook and loop fasteners, pins or other hardware may be affixed to the back of the display for positioning and repositioning on any suitable receiving mount. The display is attached by a rivet (117) to a second movable part imprinted with the cues (116) related to time. The cues related to time are viewable through a window (118) in the front portion of the display.

In a FIG. 6 embodiment the display has two hanging slots (213, 214) set 90 degrees to one another. In one position, the first slot (213) corresponds to a vertical mattress rotation. If the display is rotated, the second hanging slot (214) corresponds to a horizontal mattress rotation. As the user turns the display a different view of a mattress rotation cue (219) is shown. The display is attached by a rivet (217) to a second movable part imprinted with the cues (216) related to time. The cues (216) related to time are viewable through a cutout in the design which forms a window (218) in the front portion of the display. As with all embodiments the rotation cues may be any symbol or icon which orients the user towards a direction in which to turn the mattress (i.e vertical or horizontal plane turns). In FIG. 6 the rotation cue (219) is an ellipse.

FIG. 7 is a view of another embodiment of the present invention showing hanging slots (311, 312) located on the top and bottom of the display. The selected cue is the words that read upright. The mattress-rotation cues (313, 314) are visible on a first rotatable disk and the time related cues (316) are printed on a second rotatable disk attached behind the first disk via a rivet (317). The time related cues (316) are viewable through a viewing window (318) on the first rotatable disk.

In the FIG. 8 embodiment the months of the year (416) are imprinted on a disk. One or more mattress-rotation cues (413, 414) are imprinted on the disk. The user turns a hand (415) to select a mattress-rotation cue and turns another hand (419) to select a time-orientation cue (416). As with all embodiments the selection of cues can indicate either the time the mattress was last turned or the time of the next desired rotation.

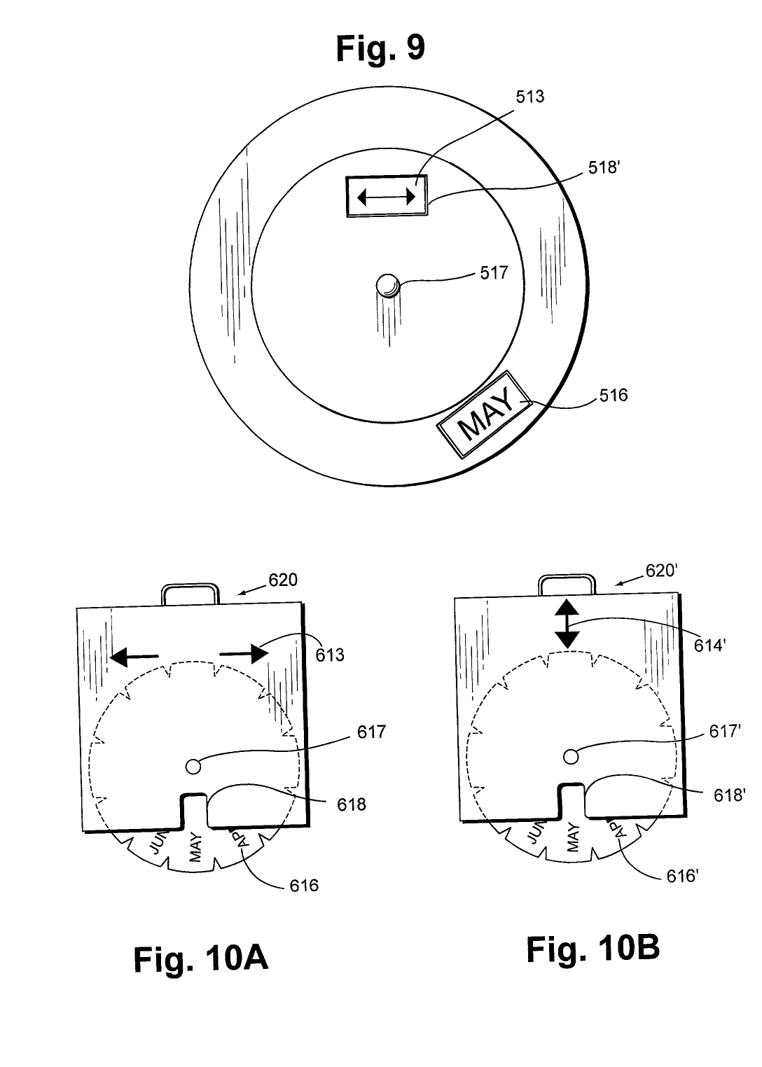

In yet another embodiment (FIG. 9) three disks are attached by a rivet (517). A second disk is imprinted with mattress-rotation cues (513). Additionally, it has either an imprinted pointer/indicator or a view window for selection of time orientation cues. A first disk has a view window (518′) through which the mattress-rotation cues are visible. A third disk is imprinted with the time orientation cues (516). The user turns the third disk to place a selected time cue beneath the view window (518) or next to a pointer indicator on the second disk. The windows are used to select and keep track of the last mattress rotation and/or to indicate the next mattress rotation. The windows may be cut away or see-thru.

Alternatively, the above embodiment can be modified to contain a first disk with a window, a second disk imprinted with mattress-rotation cues, a third disk with a window and a fourth disk imprinted with time orientation cues.

In yet another embodiment (FIG. 10) a display with a front surface (FIG. 10a) displays vertical, mattress-rotation cues which direct vertical-plane turns and a back surface (FIG. 10b) displays horizontal mattress-rotation cues. The display may be suspended from swiveling hardware (620, 620′) to be mounted against a mattress or other surface. Cues related to time (616, 616′) can be selected and are viewable through a viewing slot (618, 618′).

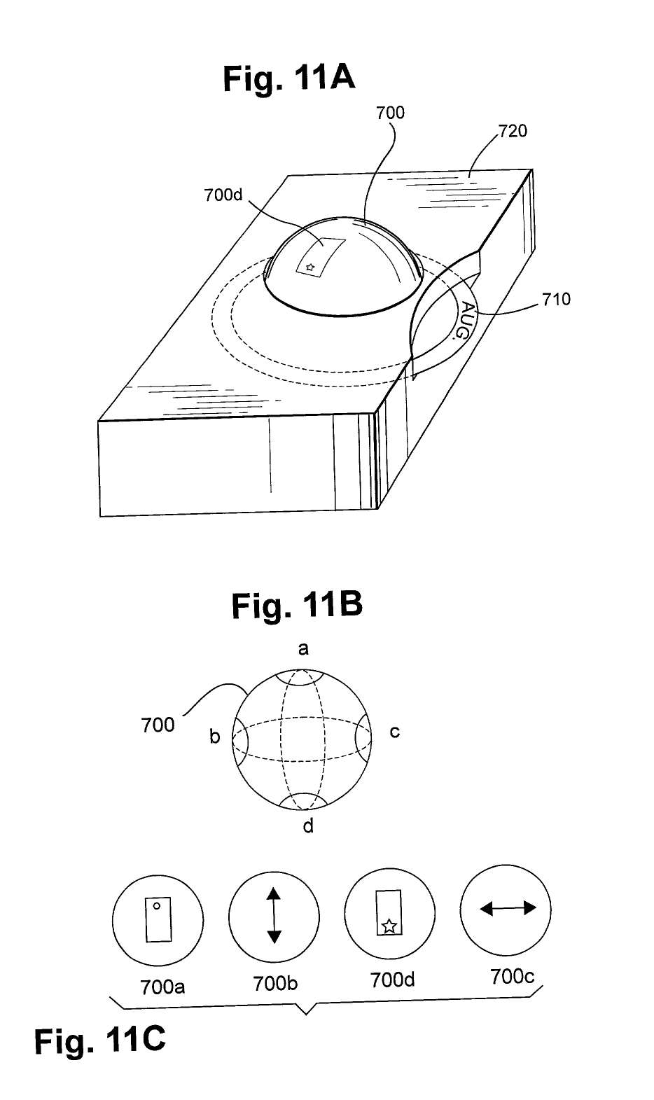

In yet another embodiment (FIGS. 11a, 11b and 11c) a sphere (700) is imprinted with a pair of icons representing the top and bottom sides of a labeled mattress (700a) (700d) and also imprinted with a pair of mattress-rotation cues (i.e., rotation of the mattress in the vertical plane (head to toe) (700b) or horizontal plane (side to side)) (700c)). The sphere (700) is seated in a box (720) that is marked or shaped to differentiate a head and a foot end of a mattress. The sphere freely rotates in a socket in the box to simulate mattress turns and provide selective views of one mattress side icon and one mattress-rotation cue at a time. A ring (710) is imprinted with the cues related to time (e.g, months of the year). The ring encircles the sphere and can be freely rotated to select and place into view the desired time cue.

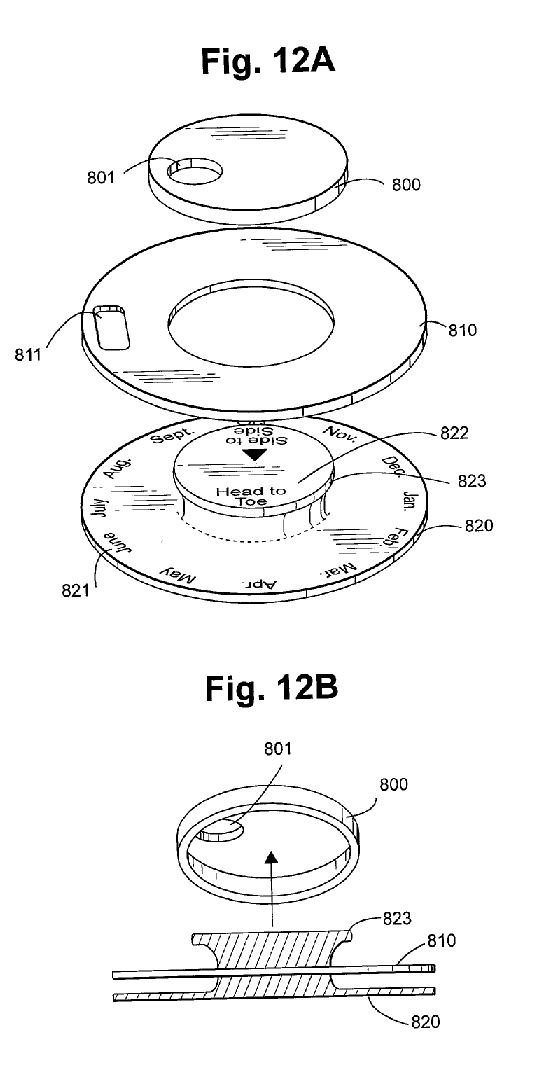

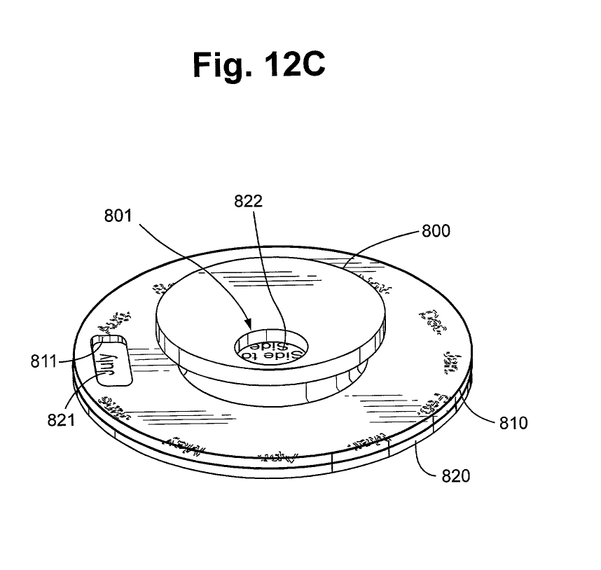

In yet another embodiment (FIG. 12), cues (821, 822) are selected by inner (800 )and outer (810) circular dials. The inner dial (800) rotates on a flange (823) encircling the top of a column. The outer dial (810) rotates on a lower encircling flange (820). The top of the column is imprinted with mattress-rotation cues (822) and the lower flange is imprinted with time-orientation cues (821). Alternatively, the top of the column is imprinted with time-orientation cues and the flange is imprinted with mattress-rotation cues. View windows (801, 811) in the rotating dials allow the user to select one time-orientation cue and one mattress-rotation cue. The back of the column unit may have an attachment feature for fastening the device to a surface such as a mattress , night stand or headboard.

In most of the embodiments of the present invention the cues related to time are represented by the twelve calendar months, however, any indicia that will provide a time reference which prompts a person to rotate the mattress, such as the seasons or holidays, can be used. The mattress-rotation cues may be one or more spatial-orientation symbols such as for example directional arrows , ellipses, organic forms, views of mattresses, verbal descriptors. Any cue which reminds a user of the next plane (i.e. head to toe or side to side) of mattress rotation can be used.

Alternatively labels affixed to the end and side of the mattress may have one or more cues related to time and one or more cues such as an arrow, related to mattress rotation. Each side of the mattress may have a different label with a cue related to time and a cue related to rotation or alternatively only a side label and a foot-end label are needed. As with all embodiments the mattress is turned from side to side or end to end, according to the sequence of time and rotation cues. Any means to mark the mattress ends can be used.

The entire disclosure[s] of all applications, patents and publications, cited herein and of corresponding patent application Ser. No. 09/756,116; filed on Jan. 9, 2001 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

We claim:

1. A mattress-rotation reminder device comprising:
a display having,
at least one mattress-rotation cue for indicating a corresponding mattress positions,
at least two cues relating to time, and,
a means for selecting a mattress-rotation cue and a cue related to time.

2. A mattress rotation reminder device according to claim 1, further comprising indicia for placement on a mattress to indicate mattress-rotation.

3. A mattress rotation reminder device according to claim 1, wherein the cues related to time are the calendar months of the year.

4. A mattress rotation reminder device according to claim 1, wherein the cues related to time are the seasons of the year.

5. A mattress rotation reminder device according to claim 1, wherein the means for selecting a mattress-rotation cue comprises a hanging slot.

6. A mattress rotation reminder device according to claim 1, wherein the means for selecting a mattress-rotation cue comprises a pointer.

7. A mattress rotation reminder device according to claim 1, wherein the means for selecting a mattress-rotation cue comprises a view window

8. A mattress rotation reminder device according to claim 1, wherein the display board is paper, wood, metal or plastic.

9. A mattress rotation reminder device according to claim 1, wherein the means for selecting a mattress-rotation cue comprises a window.

10. A mattress rotation reminder device according to claim 1, wherein the means for selecting a mattress-rotation cue comprises a tactile cue.

11. A mattress rotation reminder device according to claim 1, wherein the cues related to time are graphic images.

12. A mattress rotation reminder device comprising:
a visual mattress-rotation cue, and,
a cue related to time which prompts the user to rotate a mattress according to the mattress-rotation cue.

13. A mattress rotation reminder device according to claim 12, further comprising indicia for placement on the mattress to indicate rotation direction.

14. A method to remind a user when and in which direction to rotate a mattress comprising;
a) arranging an cue on a display device so said cue corresponds to a mattress-rotation,
b) arranging a cue on said display device so said cue corresponds to a time related icon,
c) rotating the mattress according to the cues on the display device.

15. A method to remind a user when and in which direction to rotate a mattress comprising;
a) turning a disk on a display device to select a mattress-rotation cue,
b) turning a second disk on said display device to select a time related cue, and
c) rotating the mattress according to the sequence of cues.
